(19) United States
(12) Patent Application Publication
(10) Pub. No.: US 2011/0254743 A1
(43) Pub. Date: Oct. 20, 2011

(54) PORTABLE WIRELESS DEVICE

(75) Inventors: Hiroaki Kobayashi, Miyagi (JP); Toshihiro Asahina, Kanagawa (JP); Shingo Sumi, Miyagi (JP)

(73) Assignee: PANASONIC CORPORATION, Osaka (JP)

(21) Appl. No.: 13/140,994

(22) PCT Filed: Jun. 8, 2009
(86) PCT No.: PCT/JP2009/002581

§ 371 Date: Jun. 20, 2011

(30) Foreign Application Priority Data
Dec. 24, 2008 (JP) 2008-328483

(51) Int. Cl. H01Q 21/00

(52) U.S. Cl. 343/702

(57) ABSTRACT

An object of the invention is to provide a portable wireless device that can attain a high level of antenna performance when a plurality of antenna elements is present, and for which a housing can be made thinner. Among paths between a first power supply unit 13 and a second power supply unit 14 provided at edges of a notched part 17 of a circuit board, a ground pattern of a path with a short electrical length relative to a wavelength of an operating frequency of a first wireless unit 15 or an operating frequency of a second wireless unit 16 is split to give an electrically unconnected state. In this way, ground current caused by one of the antenna elements (for example, second antenna element 12) will not flow to or will be reduced in the other antenna element (for example, first antenna element 11), so that deterioration in the characteristics of the other antenna element can be kept low.

### TECHNICAL FIELD

The present invention relates to a portable wireless device such as portable telephone and the like, and more particularly, to a portable wireless device having antenna elements of two systems operating at the same time.

### BACKGROUND ART

Recently, high functionality of a portable telephone is under way and the portable telephone is thus provided with digital TV receiving, GPS (Global Positioning System) receiving and camera functions and the like as well as a communication function.

As the digital TV receiving and GPS receiving functions are mounted, antenna elements corresponding to the respective functions are required. However, since the antenna elements operate at the same time in some cases, the antenna elements are arranged at positions at which the elements do not interfere with each other. For example, according to a mobile communication terminal disclosed in Patent Document 1, antenna elements of two systems operating at the same time are arranged at both end portions of a housing in its longitudinal direction. In other words, one of the two antenna elements is arranged at one end portion of the housing in the longitudinal direction and the other antenna is arranged at the other end portion of the housing in the longitudinal direction. By arranging the antenna elements of two systems at a wide interval, deterioration in characteristics due to electromagnetic coupling between the antenna elements is reduced.

In addition, according to a mobile communication terminal disclosed in Patent Document 2, ground patterns of circuit boards for antenna elements of two systems operating at the same time are separated and arranged at an interval in correspondence to the respective antenna elements. By separating and arranging the ground patterns at an interval, deterioration in the characteristics due to electromagnetic coupling between the antenna elements is reduced.

### RELATED ART DOCUMENTS

### Patent Documents

Patent Document 1 JP-A-2001-102954

Patent Document 2 JP-A-2006-254082

### SUMMARY OF INVENTION

### Problems to be Solved

However, when the antenna elements of two systems are arranged at both end portions of the housing in its longitudinal direction, like the mobile communication terminal of Patent Document 1, one antenna element is influenced by a user's hand, so that antenna performance of the one antenna element is deteriorated. When a user holds the housing with the hand, the user generally holds a lower part of the housing. However, when the antenna element is arranged at the end portion of the lower part, the antenna element is directly influenced by the hand. Regarding this problem, when all antenna elements are arranged at the upper end portion of the housing, the influence by the user's hand can be reduced. However, according to such configuration, it is not possible to sufficiently secure an interval between the antenna elements, so that the electromagnetic coupling between the antenna elements is caused to deteriorate the antenna performance.

When the circuit boards, on which wireless units of the antenna elements of two systems are mounted, are separately provided to secure an interval between the two circuit boards, like the mobile communication terminal of Patent Document 2, it is difficult to make the housing thinner.

The above two problems are not limited to the antenna elements of two systems and are also caused in two or more systems. In other words, the problems become worse as the number of antenna elements is increased.

The invention has been made to solve the above problems. An object of the invention is to provide a portable wireless device that can attain a high level of antenna performance when a plurality of antenna elements is present, and for which a housing can be made thinner.

### SOLUTION TO PROBLEM

A portable wireless device according to this invention comprises a housing, a circuit board that is provided to the housing and has ground patterns and a notched part, a first antenna element, a second antenna element, a first connection unit that connects the circuit board and the first antenna element, a second connection unit that connects the circuit board and the second antenna element, a first wireless unit that is connected to the first connection unit, and a second wireless unit that is connected to the second connection unit, wherein the first connection unit and the second connection unit are provided at edges of the notched part of the circuit board, and wherein among paths between the first connection unit and the second connection unit of the circuit board, a ground pattern of a path with a short electrical length relative to a wavelength of any one of an operating frequency of the first wireless unit and an operating frequency of the second wireless unit is made to be an electrically unconnected state.

According to the above configuration, among the paths between the first connection unit and the second connection unit provided at the edges of the notched part of the circuit board, a ground pattern of a path with a short electrical length relative to a wavelength of any one of the operating frequency of the first wireless unit and the operating frequency of the second wireless unit is made to be an electrically unconnected state (specifically, “split”). Therefore, the ground current caused by one antenna element (for example, second antenna element) will not flow to or will be reduced in the other antenna element (for example, first antenna element), so that deterioration in characteristics of the other antenna element can be kept low. In the meantime, a level of the frequency determines whether the ground current will flow or will be reduced. In other words, regarding a state in which the ground pattern is split but the split interval is insufficient, when the frequency is low, the state becomes close to a connected state in terms of a high frequency, so that the ground current flows a little.

In addition, the large part including the camera is arranged in the notched part of the circuit board. Thus, since it is possible to reduce a thickness of the circuit board as a thickness of the large part, it is possible to make the housing thinner.

In the above configuration of the portable wireless device according to this invention, an electrical length of at least one path among the paths between the first connection unit and the second connection unit of the circuit board is shorter than a ¼ wavelength of the operating frequency of the first wireless unit or a ¼ wavelength of the operating frequency of the second wireless unit.

According to the above configuration, a ground pattern of a path with a short electrical length relative to a wavelength of any one of the operating frequency of the first wireless unit and the operating frequency of the second wireless unit is made to be an electrically unconnected state. Thus, even when an interval between the first connection unit and the second connection unit is shorter than the ¼ wavelength of the operating frequency of the first wireless unit or the ¼ wavelength of the operating frequency of the second wireless unit, the electromagnetic coupling between the antenna elements is caused little. Accordingly, it is possible to closely arrange the two antenna elements, thereby saving a space.

In the above configuration, the notched part is provided at an upper end part of the circuit board.

According to the above configuration, since the notched part is provided at the upper end part of the circuit board, when the camera is arranged in the notched part, a possibility that the camera will be covered by a user's hand is low. Accordingly, when taking a photograph with the camera, a failure that the hand is taken will not occur.

In the above configuration, among the paths between the first connection unit and the second connection unit of the circuit board, a reactance circuit is provided between unconnected ground patterns of the path with the short electrical length relative to the wavelength of any one of the operating frequency of the first wireless unit and the operating frequency of the second wireless unit.

According to the above configuration, the reactance circuit is provided. Thus, it is possible to lengthen the path length in terms of a high frequency, thereby removing the electromagnetic coupling between the antenna elements.

### ADVANTAGEOUS EFFECTS OF INVENTION

According to the invention, it is possible to attain a high level of antenna performance when a plurality of antenna elements is present and to make the housing thinner.

### BRIEF DESCRIPTION OF DRAWINGS

FIG. 1 is a plan view showing a front side and a rear side of a portable wireless device according to a first embodiment of the invention.

FIG. 2 is a plan view showing an inside of a lower housing of the portable wireless device shown in FIG. 1.

FIG. 3 is a plan view for illustrating ground patterns of two paths in the lower housing of the portable wireless device shown in FIG. 1.

FIG. 4 is a plan view for illustrating a characteristic of the portable wireless device shown in FIG. 1.

FIG. 5 is a plan view for illustrating a characteristic of the portable wireless device shown in FIG. 1.

FIG. 6 is a plan view showing an inside of a lower housing of a portable wireless device according to a second embodiment of the invention.

### DESCRIPTION OF EMBODIMENTS

Hereinafter, embodiments of the invention will be specifically described with reference to the drawings.

### First Embodiment

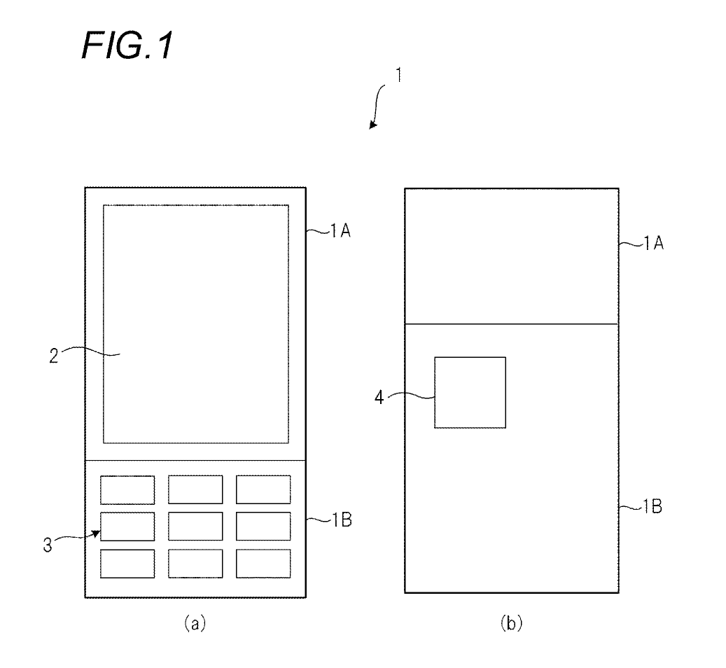

FIG. 1 is a plan view showing a front side and a rear side of a portable wireless device according to a first embodiment of the invention, in which FIG. 1(a) shows the front side and FIG. 1(b) shows the rear side. In FIG. 1, a portable wireless device 1 according to this embodiment is a sliding-type portable wireless device that has two housings, one housing (hereinafter, referred to as “upper housing”) 1A is slid relatively to the other housing (hereinafter, referred to as “lower housing”) 1B for opening and closing. FIG. 1 shows an opened state. A front side of the upper housing 1A is provided with a rectangular display 2 that is slightly smaller than one surface of the upper housing 1A. A front side of the lower housing 1B is provided at its lower part with a key operation unit 3 including a plurality of keys. In addition, a rear side of the lower housing 1B is provided at its upper part with a camera 4.

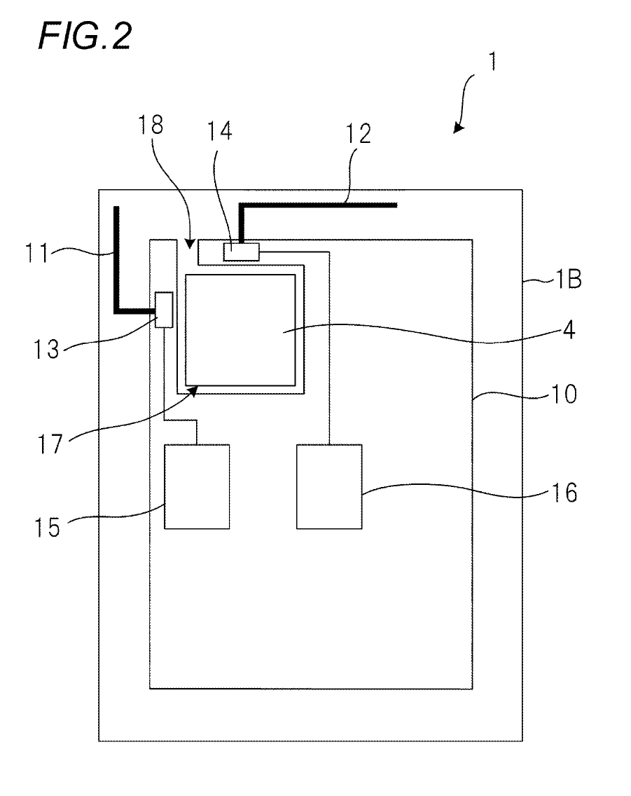

As shown in FIG. 2, the portable wireless device 1 has a circuit board 10, a first antenna element 11, a second antenna element 12, a first power supply unit (first connection unit) 13 that connects the circuit board 10 and the first antenna element 11, a second power supply unit (second connection unit) 14 that connects the circuit board 10 and the second antenna element 12, a first wireless unit 15 that is connected to the first power supply unit 13, and a second wireless unit 16 that is connected to the second power supply unit 14. FIG. 2 is a plan view showing an inside of the lower housing 1B of the portable wireless device 1. As shown in FIG. 2, a rectangular notched part 17 for allowing the camera 4 to pass through is formed at an upper part of the circuit board 10.

When the camera 4 is mounted to the portable wireless device 1, if a photographing surface of the camera is covered by a hand of a user, it is not possible to normally take a photograph (i.e., the hand is taken, so that a failure occurs). Accordingly, the notched part 17 for allowing the camera 4 to pass through is formed at the upper part of the circuit board 4 so that the camera 4 is not covered by the hand when the portable wireless device 1 is held by the user. In this embodiment, the notched part 17 for camera is formed. However, the notched part may be formed for the other large part other than the camera. The camera 4 is mounted so as to pass it through the notched part 17 formed at the circuit board 10 without mounting the large part including the camera 4 on the circuit board 10 or without mounting the large part separately from the circuit board 10. Therefore, it is possible to make the housing thinner. In other words, it is possible to absorb a thickness of the circuit board 10 into a thickness of the large part, so that the housing can be made thinner as much.

In this embodiment, an operating frequency of the first wireless unit 15 is set to a frequency (470 to 770 MHz) of a digital TV and an operating frequency of the second wireless unit 16 is set to a frequency (1575 MHz) of GPS. In this case, since both the first wireless unit 15 and the second wireless unit 16 are used for only receiving, both the first power supply unit 13 and the second power supply unit 14 serves as connection units.

The first power supply unit 13 and the second power supply unit 14 are provided at edges of the notched part 17 of the circuit board 10, as shown in FIG. 2, and an interval of the edges is within a ¼ wavelength of the using frequency (operating frequency of the second wireless unit 16) of the second antenna element 12. By providing the first power supply unit 13 and the second power supply unit 14 to the upper part of the circuit board 10 in addition to the notched part 17, it is possible to reduce the influence of the hand and to thus improve the antenna characteristics.

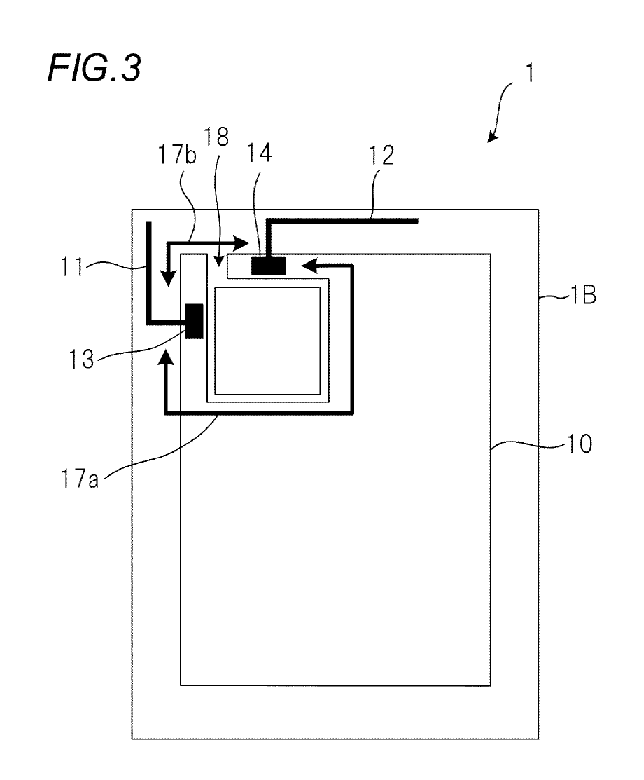

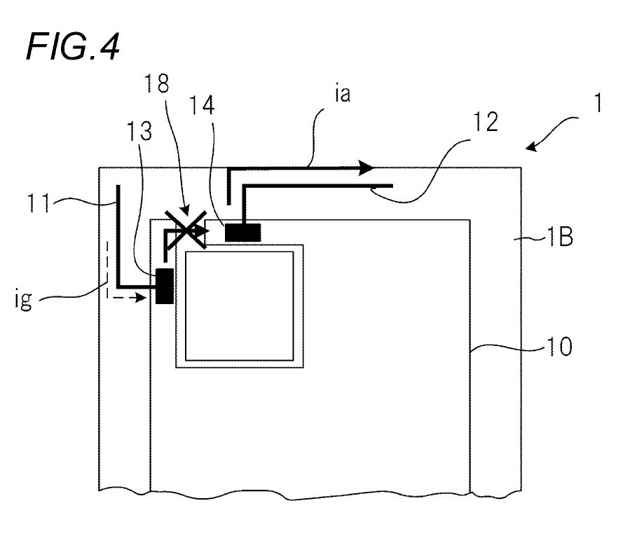

Ground patterns of two paths are present between the first power supply unit 13 and the second power supply unit 14 of the circuit board 10. Among them, the ground pattern of a path with a short electrical length relative to the operation frequency of the second wireless unit 16 is split to give an electrically unconnected state. FIG. 3 shows the ground patterns of paths between the first power supply unit 13 and the second power supply unit 14. In FIG. 3, a path 17a is longer than a path 17b and the ground pattern of the short path 17b is split. A reference numeral 18 indicates the split portion. In this way, among the ground patterns of two paths between the first power supply unit 13 and the second power supply unit 14, the ground pattern with the short electrical length is split. Thus, when antenna current ia flows to the second antenna element 12, as shown in FIG. 4, ground current ig caused by the second antenna element 12a will not flow to or will be reduced in the first antenna element 11 even when it flows, compared to a configuration where the ground pattern is not split.

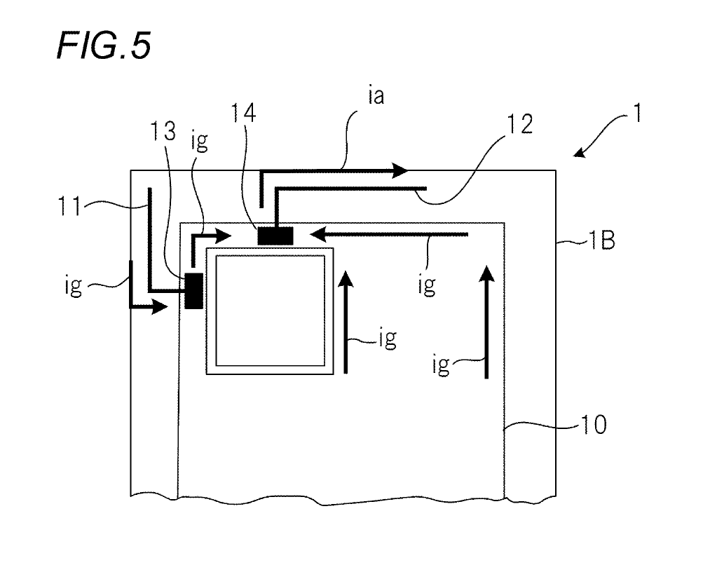

As a comparative example, an example where all the ground patterns of the paths between the first power supply unit 13 and the second power supply unit 14 are not split is shown in FIG. 5. Also in this example, the interval between the first power supply unit 13 and the second power supply unit 14 is within the ¼ wavelength of the using frequency (operating frequency of the second wireless unit 16) of the second antenna element 12. Under state in which the ground pattern is not split, when the antenna current ia flows to the second antenna element 12, the ground current ig caused by the second antenna element 12 flows to the first antenna element 11 through a ground pattern of a path with a short electrical length. In particular, since the first power supply unit 13 and the second power supply unit 14 are close to each other within the interval of the ¼ wavelength, much ground current ig flows. As the ground current ig flows to the first antenna element 11, the ground current ig is consumed by the first wireless unit 15 connected to the first antenna element 11. As a result, since the ground current of the second antenna element 12 is reduced (electromagnetic coupling between the antenna elements), the antenna characteristic is also deteriorated.

On the contrary, according to the invention, among the ground patterns of the two paths between the first power supply unit 13 and the second power supply unit 14, the ground pattern of the path with the short electrical length relative to the wavelength of the operating frequency of the second wireless unit 16 is split. Therefore, even when the first power supply unit 13 and the second power supply unit 14 are close to each other within the interval of the ¼ wavelength, the electromagnetic coupling between the antenna elements is little caused, so that it is possible to reduce the deterioration in the characteristics of the antenna element.

Like this, the ground pattern of the path with the short electrical length relative to the operating frequency of the second wireless unit 16 is split, so that the influence on the first antenna element 11 is substantially removed and the deterioration in the characteristics of the second antenna element 12 can be thus reduced. This is also the same as a case where the antenna current flows to the first antenna element 11. In the meantime, an amount of the ground current is determined by a level of the frequency and a split interval of the ground pattern. In other words, for a state in which the ground pattern is split but the split interval is narrow, when the frequency is low, the state becomes close to a connected state in terms of a high frequency, so that the ground current flows a little. On the contrary, when the frequency is high, no ground current flows even when the split interval is narrow.

As described above, according to the portable wireless device 1 of this embodiment, among the paths between the first power supply unit 13 and the second power supply unit 14 provided at the edges of the notched part 17 of the circuit board 10, the ground pattern of the path with a short electrical length relative to the wavelength of the operating frequency of the first wireless unit 15 or the operating frequency of the second wireless unit 16 is split to give an electrically unconnected state. Accordingly, the ground current caused by one antenna element (for example, second antenna element 12) will not flow to or will be reduced in the other antenna element (for example, first antenna element 11), so that the deterioration in the characteristics of the other antenna element can be kept low.

In addition, even when the interval between the first power supply unit 13 and the second power supply unit 14 is shorter than the ¼ wavelength of the operating frequency of the first wireless unit 15 or the ¼ wavelength of the operating frequency of the second wireless unit 16, the electromagnetic coupling between the antenna elements is caused little. Accordingly, it is possible to closely arrange the first antenna element 11 and the second antenna element 12, thereby saving the space.

Also, the large part including the camera 4 is arranged in the notched part 17 of the circuit board 10. Thus, since it is possible to subtract the thickness of the circuit board 10 from the thickness of the large part, it is possible to make the housing thinner.

Additionally, since the notched part 17 of the circuit board 10 is provided at the upper end part of the circuit board 10, when the camera 4 is arranged in the notched part 17, a possibility that the camera will be covered by a user's hand is low. Accordingly, when taking a photograph with the camera, a failure that the hand is taken will not occur.

In this embodiment, as the criterion for splitting the ground pattern, the wavelength of the operating frequency of the second wireless unit 16 is used. However, the wavelength of the operating frequency of the first wireless unit 15 may be also used. In other words, among the ground patterns of the paths between the first power supply unit 13 and the second power supply unit 14, a ground pattern of a path with a short electrical length relative to any one wavelength of the operating frequency of the first wireless unit 15 and the operating frequency of the second wireless unit 16 is split.

### Second Embodiment

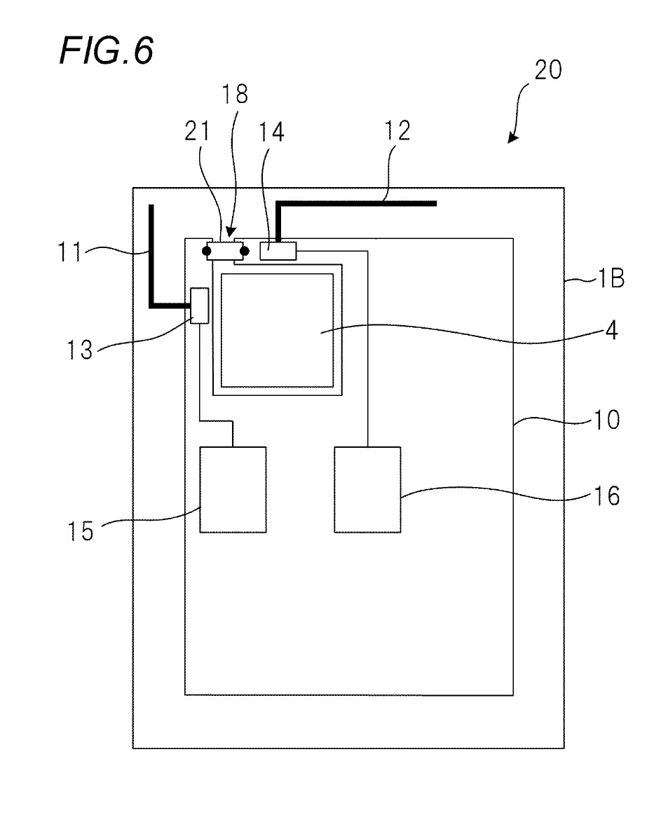

FIG. 6 is a plan view showing an inside of a lower housing of a portable wireless device according to a second embodiment of the invention. In FIG. 6, the parts common to those of FIG. 2 are indicated with the same reference numerals and the descriptions thereof are omitted.

In FIG. 6, according to a portable wireless device 20 of this embodiment, a reactance circuit 21 is inserted in a split portion 18 of the ground pattern. Therefore, both ends of the split portion 18 of the ground pattern are electrically connected to each other. Depending on the frequency bands, it is not possible to completely remove the electromagnetic coupling between the antenna elements just by splitting the ground pattern of the circuit board 10. In other words, as described above, although the electrically unconnected state is formed, the electrically unconnected state may become a connected state in terms of a high frequency. Accordingly, by inserting the reactance circuit 21 in the split portion 18, the path length can be extended seemingly in terms of a high frequency, so that it is possible to sufficiently secure the interval between the power supply units of the antenna elements. Therefore, it is possible to remove the electromagnetic coupling between the antenna elements.

As described above, according to the portable wireless device 20 of this embodiment, among the paths between the first power supply unit 13 and the second power supply unit 14 of the circuit board 10, the reactance circuit 21 is provided between the unconnected ground patterns of the path with a short electrical length relative to any one wavelength of the operating frequency of the first wireless unit 15 and the operating frequency of the second wireless unit 16. Accordingly, it is possible to lengthen the path length in terms of a high frequency, thereby removing the electromagnetic coupling between the antenna elements.

In the meantime, the invention can be applied to a foldable-type portable wireless device or a straight-type portable wireless device having one housing, in addition to the sliding-type portable wireless devices 1, 20. In addition, the invention can be applied to a wireless device such as PDA and a handheld PC having a communication function, a transceiver and the like.

Although the invention has been specifically described with reference to the specific embodiments, it is apparent to one skilled in the art that the embodiments can be changed or modified without departing from the spirit and the scope of the invention.

The present application is based on Japanese Patent Application No. 2008-328483 filed on Dec. 24, 2008, the contents of which are incorporated herein by reference.

### INDUSTRIAL APPLICABILITY

The invention realizes the effects of attaining a high level of antenna performance when a plurality of antenna elements is present and making the housing thinner and can be applied to a portable wireless device such as portable telephone and the like.

### INDUSTRIAL APPLICABILITY

1, 20: portable wireless device

1A: upper housing

1B: lower housing

2: display

3: key operation unit

4: camera

10: circuit board

11: first antenna element

12: second antenna element

13: first power supply unit

14: second power supply unit

15: first wireless unit

16: second wireless unit

17: notched part

18: split portion of ground pattern

21: reactance circuit

1. A portable wireless device comprising:
a housing;
a circuit board that is provided to the housing and has ground patterns and a notched part;
a first antenna element;
a second antenna element;
a first connection unit that connects the circuit board and the first antenna element;
a second connection unit that connects the circuit board and the second antenna element;
a first wireless unit that is connected to the first connection unit; and
a second wireless unit that is connected to the second connection unit,
wherein the first connection unit and the second connection unit are provided at edges of the notched part of the circuit board; and
wherein among paths between the first connection unit and the second connection unit of the circuit board, a ground pattern of a path with a short electrical length relative to a wavelength of any one of an operating frequency of the first wireless unit and an operating frequency of the second wireless unit is made to be an electrically unconnected state;
wherein among the paths between the first connection unit and the second connection unit of the circuit board, a reactance circuit is provided between unconnected ground patterns of the path with the short electrical length relative to the wavelength of any one of the operating frequency of the first wireless unit and the operating frequency of the second wireless unit.

2. The portable wireless device according to claim 1, wherein an electrical length of at least one path among the paths between the first connection unit and the second connection unit of the circuit board is shorter than a ¼ wavelength of the operating frequency of the first wireless unit or a ¼ wavelength of the operating frequency of the second wireless unit.

3. The portable wireless device according to claim 1, wherein the notched part is provided at an upper end part of the circuit board.

4. (canceled)
